(19) United States
(12) Patent Application Publication
(10) Pub. No.: US 2019/0121944 A1
(43) Pub. Date: Apr. 25, 2019

(54) INSURANCE-COMPLIANT ELECTRONIC ORDERING OF BIOLOGICAL SAMPLE TESTING

(71) Applicant: Millennium Health, San Diego, CA (US)

(72) Inventors: JENNIFER STRICKLAND, San Diego, CA (US); ANGELA G. HUSKEY, San Diego, CA (US); MARIA CHIANTA, San Diego, CA (US)

(73) Assignee: Millennium Health, San Diego, CA (US)

(21) Appl. No.: 15/792,362

(22) Filed: Oct. 24, 2017

(51) Int. Cl. G06F 19/00

(52) U.S. Cl. CPC G06F 19/328; G06F 3/0482; G06F 19/3406; G06F 19/366

(57) ABSTRACT

A computer implemented method of ordering a laboratory test for a biological sample collected from a patient includes obtaining multiple sets of payor-specific ordering guidelines, obtaining an indication or a payor identity selecting payor-specific ordering guidelines based on the indication of the payor identity, displaying payor-specific ordering guidelines on a graphical user interface, and obtaining patient-specific data required by the payor to issue a reimbursement for the laboratory test based on the selected set of payor-specific guidelines.

### TECHNICAL FIELD

The disclosed technology relates generally to laboratory testing of biological samples, and more particularly various embodiments relate to systems and methods for insurance-compliant electronic ordering of biological sample screening and diagnostic testing.

### BACKGROUND

Government and private payors (e.g., healthcare insurance plans) who ultimately pay for urine and oral fluid drug testing increasingly have instituted policies that set forth in detail the circumstances under which such testing can be ordered and reimbursed. At the same time, the use of electronic ordering platforms for purposes of ordering urine and oral fluid drug testing has proliferated. Unfortunately, existing electronic ordering platforms used for purposes of ordering urine and oral fluid drug testing are not customizable to payor policies, and thus are limited in their ability to help to ensure that tests ordered using the platform conform to payor urine and oral fluid drug testing policies and instead, merely replicate paper test requisition forms. Reimbursement policies for different payors may be unique to the payor and/or different from policies of other payors. As a result, laboratories who perform urine and oral fluid drug testing and the payors who pay for such testing must rely almost exclusively on the ordering healthcare providers to follow payor testing policies on their own volition when ordering tests via electronic platform. This results in the submission of test orders by health care providers that often do not comply with payor policies because the order (1) fails to document medical necessity in the way required by the payor, (2) fails to follow payor “screen-first” requirements that require a pre-screening test of the bio-sample prior to performing a more definitive test, and/or (3) exceeds the number of orders submitted per patient as allowed by the payor over a given period of time. Consequently, the submission of claims by laboratories performing tests ordered by those physicians are often deemed not to be reimbursable.

### BRIEF SUMMARY OF EMBODIMENTS

Embodiments of the present disclosure provide systems and methods for obtaining a payor-specific policy compliant order for a healthcare-related test, procedure, or pharmaceutical product. In some embodiments, a method for obtaining a reimbursable order for a laboratory screening or diagnostic test of a bio-sample is provided. For example, the method may include obtaining an indication of the identity of an intended payor for reimbursement of the laboratory test prior to transmitting the order for the test. The payor identity may then be used to select a set of payor-specific ordering requirements for the identified payor and obtain input from a user interface to satisfy the payor-specific ordering requirements. The order may then be completed and transmitted to the laboratory, and then to the payor for reimbursement together with the input collected in response to the payor-specific ordering requirements. By collecting the payor-specific information required by the payor prior to transmitting the order to the laboratory, the likelihood that the laboratory test will be reimbursed by the payor may be increased, as will the collection rates achieved by the laboratory. Notably, this same method may be applied to other medical provider and/or pharmaceutical practices for increasing collection rates and avoiding claim denials from payors. Embodiments disclosed herein also provide systems for applying the methods for obtaining a reimbursable order for a laboratory screening or diagnostic tests described herein.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 illustrates an example system for insurance-compliant electronic ordering of biological sample screening and diagnostic testing, consistent with embodiments disclosed herein.

FIG. 2 is a flow chart illustrating an example method for ordering a laboratory test for a biological sample, consistent with embodiments disclosed herein.

FIG. 3 is a flow chart illustrating an example method for completing an order for a laboratory test for a biological sample, consistent with embodiments disclosed herein.

FIG. 4 is a flow chart illustrating an example method for ordering a laboratory test for a biological sample, consistent with embodiments disclosed herein.

FIG. 5 illustrates an example screen shot of a graphical user interface (GUI) used connection with embodiments disclosed herein.

FIG. 6 illustrates an example screen shot of a GUI used connection with embodiments disclosed herein.

FIG. 7 illustrates an example screen shot of a GUI used connection with embodiments disclosed herein.

FIG. 8 illustrates an example screen shot of a GUI used connection with embodiments disclosed herein.

FIG. 9 illustrates an example computing system that may be used in implementing various features of embodiments of the disclosed technology.

The figures are not intended to be exhaustive or to limit the invention to the precise form disclosed. It should be understood that the invention can be practiced with modification and alteration, and that the disclosed technology be limited only by the claims and the equivalents thereof.

### DETAILED DESCRIPTION OF THE EMBODIMENTS

Embodiments of the technology disclosed herein are directed toward a system and method for insurance-compliant electronic ordering of biological sample screening and diagnostic testing. For example, a biological sample may be urine, blood, oral fluid, mucus, cellular material, and/or DNA material collected from a patient. A screening test may be a drug screening, disease screening, DNA screening, or other laboratory screening test as known in the art. Drug screening tests may be tests for illicit, abused, or prescription drugs, alcohol, opioids, THC, benzodiazepines, stimulants, prescription drugs, metabolites, antidepressants, antipsychotics, muscle relaxants, anticonvulsants, or other drug screening tests or diagnostic tests as known in the art. A diagnostic test may be a laboratory test of the biological sample designed to diagnose a medical condition and/or identify a treatment plan. Embodiments disclosed herein provide systems and methods for verifying payor-specific requirements prior to transmitting in order for the biological sample screening or diagnostic test.

In some embodiments, a computer implemented method of ordering a laboratory test for a biological sample collected from a patient includes obtaining multiple sets of payor-specific ordering guidelines from a data store and obtaining an indication or a payor identity from a user interface. The method may also include selecting, with a payor-compliance logical circuit, one of the sets of payor-specific ordering guidelines based on the indication of the payor identity and displaying the ordering guidelines on the user interface. The method may also include obtaining, from the graphical user interface, a set of patient-specific data required by the payor to issue a reimbursement for the laboratory test based on the selected set of payor-specific guidelines.

In some examples, the payor-specific ordering guidelines may include a medical necessity flag, a pre-screening flag, a frequency limit flag, or a list of payor-approved laboratory test types. As used herein, a flag may be an indicator in a set of computer executable instructions to identify that a trigger condition exists that may indicate to the processor that a decision should be made depending on the value of the indicator. For example, the medical necessity flag may indicate whether the payor requires a description of the medical necessity for the particular screening or diagnostic test prior to performing the laboratory test, in order to reimburse the laboratory for running the test.

The pre-screening flag may indicate a requirement by the payor that a presumptive test be run at either the point-of-care by the ordering physician or by the laboratory (e.g., using immunoassay technology). For example, the presumptive test may give a general indication as to whether or not a drug class is present in a bio-sample, without identifying the specific drug. Based on the result, the physician may the payor policy may then either permit or prohibit the ordering of a definitive drug test to specifically identify the drug present in the bio-sample. In some examples, the definitive drug test may be liquid chromatography mass spectrometry (LCMS) or gas chromatography (GCMS).

In some examples, the payor may require additional information about the patient or the test being run to enable reimbursement. In these examples, the payor-specific ordering guidelines may include an additional information flag. The additional information flag may indicate a requirement to collect additional information from the patient, for example, relating to medical history, risk assessment, financial responsibility, or other relevant criteria, prior to performing the laboratory test, in order to reimburse the laboratory for running the test.

The frequency limit flag may indicate a limit on the number of biological samples sent for laboratory testing that may be reimbursed by the payor for a particular patient in a given period of time. The biological sample may be urine, blood, or oral fluid.

Some embodiments of the method include obtaining an indication of payor identity by displaying a list of available payors on the user interface, and obtaining a user selection of a desired payor.

In some examples, the method includes setting the medical necessity flag to true if identifying a medical necessity is required by the payor. The method may include identifying that the medical necessity flag should be set to true based on the payor identity. The method may also include displaying a medical necessity input field on the graphical user interface, obtaining a user description of medical necessity entered into the medical necessity input field, and storing the user description of medical necessity in the data store. In some examples, method may include transmitting an order for the laboratory test after obtaining the user description of medical necessity. In some examples, the method may include transmitting a request for reimbursement to the payor, wherein the request for reimbursement includes the user description of medical necessity.

In some examples, the method includes setting the pre-screening flag to true if pre-screening is required by the payor (e.g., as identified by the indication of the payor identity) and displaying a pre-screening input field on the graphical user interface. The method may also include obtaining an pre-screening criteria (e.g., an indication as to whether a pre-screening test was performed), and storing the pre-screening criteria in the data store. In some examples, the method includes transmitting an order for the laboratory test after obtaining the set of pre-screening criteria. In some examples, the method includes transmitting a request for reimbursement to the payor that includes the set of pre-screening criteria.

In some examples, the method includes setting the frequency limit flag to a payor-specific frequency threshold if a payor-specific frequency threshold is required by the payor identified by the indication of the payor identity and displaying the payor-specific frequency threshold and an indication of a frequency at which the laboratory test had been performed for the patient on the graphical user interface. The method may also include displaying, on the graphical user interface, a warning message if the indication of the frequency at which the laboratory test had been performed for the patient is equal to or exceeds the payor-specific frequency threshold. Some embodiments may include displaying a warning message if the laboratory test does not match any of the payor-approved laboratory test types.

Some embodiments of the disclosure provide a system for ordering a laboratory test for a biological sample collected from a patient. The system may include a data store, a payor-compliance logical circuit, and a graphical user interface. For example, the payor-compliance logical circuit may include a processor and a non-transitory medium with computer executable instructions embedded thereon, the computer executable instructions configured to cause the processor to obtain multiple sets of payor-specific ordering guidelines from the data store, obtain an indication or a payor identity from the graphical user interface, select one of the sets of payor-specific ordering guidelines based on the indication of the payor identity, and display ordering guidelines from the set of payor-specific ordering guidelines on the graphical user interface. The system may also obtain, from the graphical user interface, a set of patient-specific data required by the payor to issue a reimbursement for the laboratory test based on the set of payor-specific guidelines.

Some examples of the system may also display a list of available payors, and obtaining a user selection of a desired payor. In some examples, system may set the medical necessity flag to true if identifying medical necessity is required by the payor identified by the indication of the payor identity display a medical necessity input field, obtain a description of medical necessity entered into the medical necessity input field, and store the description of medical necessity. In some examples, the system may transmit an order for the laboratory test after obtaining the user description of medical necessity. In some examples, the system may transmit a request for reimbursement to the payor. The request for reimbursement may include the description of medical necessity.

In some examples, the system may set the pre-screening flag to true if pre-screening is required by the payor identified by the indication of the payor identity. The system may display a pre-screening input field obtain a pre-screening criteria entered into the pre-screening input field (e.g., an indication that a pre-screening test was performed), and store the pre-screening criteria in a data store. In some examples, the system may transmit an order for the laboratory test after obtaining the set of pre-screening criteria. In some examples, the system may transmit a request for reimbursement to the payor, the request for reimbursement comprising the set of pre-screening criteria.

In some examples, the system may set the frequency limit flag to a payor-specific frequency threshold if a payor-specific frequency threshold is required by the payor identified by the indication of the payor identity and display the payor-specific frequency threshold and an indication of a frequency at which the laboratory test had been performed for the patient. The system may also display a warning message if the indication of the frequency at which the laboratory test had been performed for the patient is equal to or exceeds the payor-specific frequency threshold. The system may display, on the graphical user interface, a warning message if the laboratory test does not match any of the payor-approved laboratory test types.

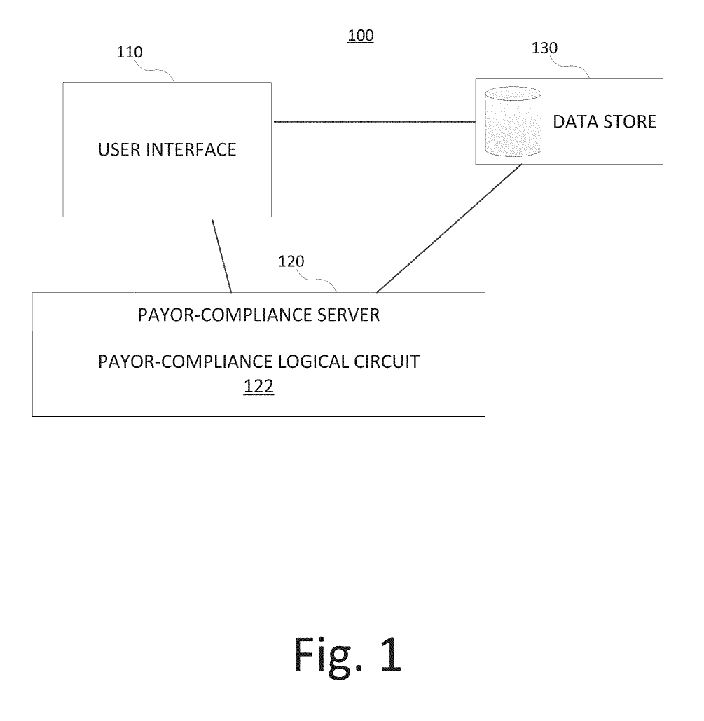

FIG. 1 illustrates an example system for insurance-compliant electronic ordering of biological sample screening and diagnostic testing 100. As illustrated, system 100 may include user interface 110. For example, user interface 110 may include a mobile device, laptop computer, desktop computer, tablet computer, or other user interface device as known in the art. In some examples, user interface 110 may be a graphical user interface or a voice recognition user interface. User interface 110 may include a processor and a non-volatile data storage medium with computer executable instructions embedded thereon, the computer executable instructions configured to cause the processor to present information to a user, e.g., via a traditional display, touchscreen display, voice interface, or other interface is known in the art.

System 100 may also include payor-compliance server 120 and data store 130. For example, payor compliance server 120 may be communicatively coupled to user interface 110 and/or data store 130, e.g., via a direct wired connection, a wireless connection, a local area network, or a wide area network. In some examples, payor compliance server 120 may be located in a cloud and/or behind a firewall device. Payor compliance server 120 may include a payor compliance logical circuit 122 configured to communicate with user interface 110 and a data store 130. Payor compliance logical circuit 122 may include a processor and a non-volatile data storage medium with computer executable instructions embedded thereon, the computer executable instructions configured to cause the processor to perform a method or methods for ordering a laboratory test for a biological sample as disclosed herein.

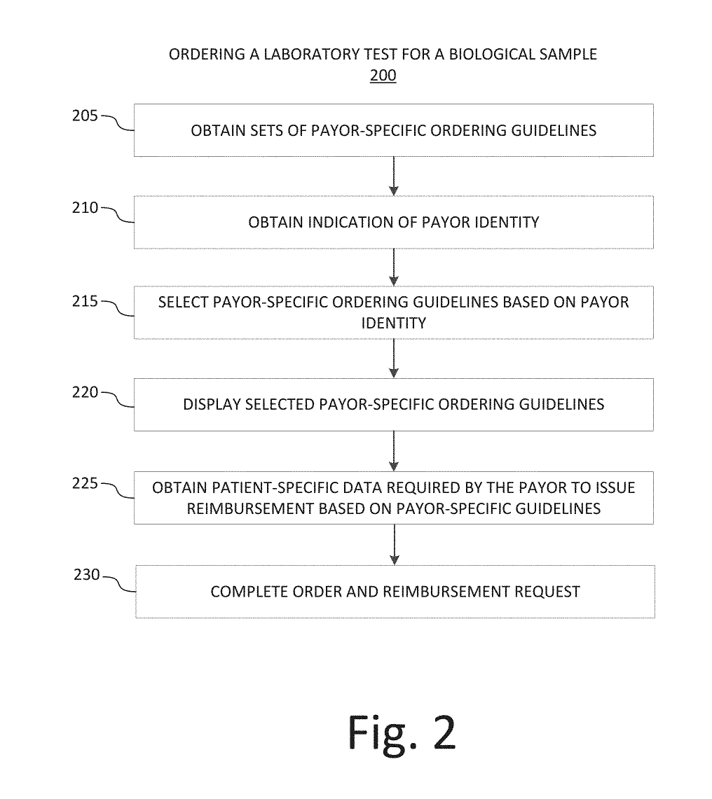

FIG. 2 is a flow chart illustrating an example method for ordering a laboratory test for a biological sample 200. As illustrated, method 200 may include obtaining sets of payor specific ordering guidelines at step 205 and obtaining an indication of payor identity at step 210. For example, a set of payor specific ordering guidelines may be obtained from data store 130, or from a payor managed database. Payor specific guidelines may include requirements from an insurance company, or other payor, for processing a reimbursement request for a laboratory test.

In some embodiments, method 200 may include obtaining an indication of payor identity at step 210. For example, the indication of payor identity may include information sufficient to identify a payor that may reimburse a laboratory for performing the laboratory test. The payor may be a healthcare insurance company, self-insuring corporation, or other lender, creditor, or insurer with financial The indication may include the name, address, or other identifying information relating to the payor.

Method 200 may also include selecting payor-specific ordering guidelines based on the payor identity at step 215. For example, a payor-compliance logical circuit may query data store 130 for payor-specific ordering guidelines that correspond to a particular payor or class of payor. Method 200 may also include displaying the selected payor-specific ordering guidelines on a user interface at step 220. In some examples, the selected payor-specific ordering guidelines may be presented to a user via audio or tactile signaling, in addition to or instead of displaying the guidelines on a user interface. The payor-specific ordering guidelines may provide information to the user and/or the payor-compliance logical circuit indicating specific requirements from the payor to enable the payor to reimburse a laboratory for performing a laboratory test. In some embodiments, the payor-specific ordering guidelines may be used to verify reimbursable requirements from a payor or payor type for other medical procedures or reimbursements, including for providing diagnostic tests, imaging, screening, invasive or non-invasive procedures, or ordering pharmaceutical products.

In some embodiments, method 200 includes obtaining patient-specific data required by the payor to issue reimbursement based on the selected payor-specific guidelines at step 225. For example, if the payor-specific ordering guidelines include obtaining a medical necessity, then the payor-compliance logical circuit would set a medical necessity flag and obtain, from the user interface, a description of the medical necessity for the patient to have the laboratory test performed. In some examples, the medical necessity may be based on an order from a physician to screen for or assist in the diagnosis of certain medical conditions based on a patient's prior medical examination. In some examples, the medical necessity may be based on a suspected drug addiction or misuse. The medical necessity flag may also change the menu structure or tree presented in the user interface, for example, to display additional queries or sub-menus based on payor requirements.

In some examples, the payor-specific ordering guidelines may include a pre-screening flag that triggers the payor-compliance logical circuit to display a pre-screening requirement on the user interface. For example, the pre-screening requirement may be a requirement to perform a pre-screening test on the bio-sample to determine whether or not a particular class of drugs is present. If the pre-screening test is positive, then a specific drug screening test may be performed to identify the specific drug present in the bio-sample. If the pre-screening test is negative, the specific drug test may not be performed according to payor guidelines.

The payor-specific ordering guidelines may include flags requiring additional information or setting additional limitations, for example, on the type of test ordered, the frequency of repeated tests permitted, or other information relevant to payor reimbursement as known in the art.

In some embodiments, method 200 may include completing an order and submitting the order for reimbursement to the payor at step 230. The order may be started after the payor-specific ordering guidelines are satisfied. In other embodiments, the order may be started before the payor-specific ordering guidelines are satisfied, but may be completed and transmitted to the laboratory after the payor-specific ordering guidelines are satisfied.

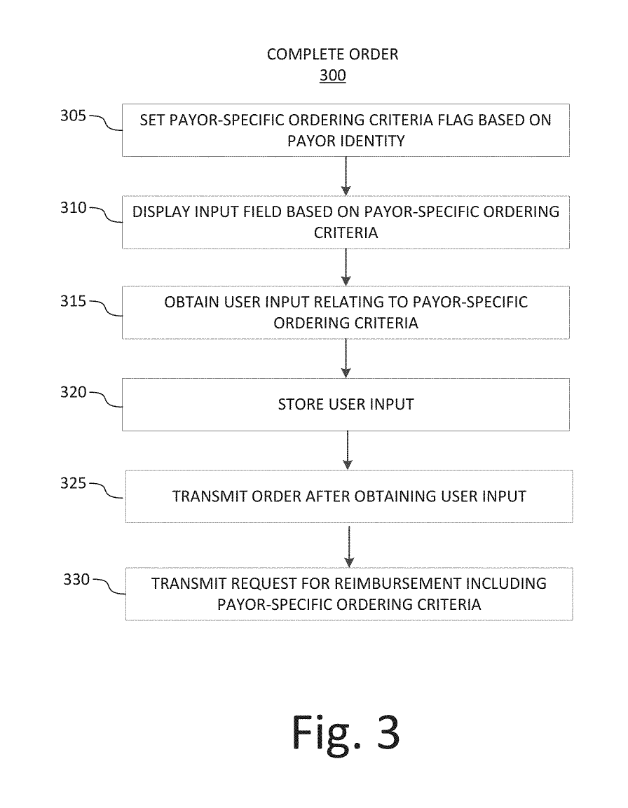

FIG. 3 is a flow chart illustrating an example method 300 for completing an order for a laboratory test for a biological sample. As illustrated, method 300 may include setting a payor-specific ordering criteria flag based on payor identity at step 305. For example, the payor-specific ordering criteria flag may be a medical necessity flag, a pre-screening flag, a frequency flag, or flags indicating other payor-specific reimbursement requirements as known in the art. In some embodiments, method 300 may include setting multiple payor-specific ordering criteria flags according to payor-specific ordering guidelines. Method 300 may also include displaying an input field, for example, on a graphical user interface, based on the payor-specific ordering criteria flag at step 310. Method 300 may also include obtaining user input relating to the payor-specific ordering criteria flag. For example, the user input may be information responsive to or that satisfies the payor-specific ordering criteria required by the payor for reimbursement. The user input may be stored in a data store at step 320.

Still referring to FIG. 3, method 300 may also include transmitting an order to the laboratory at step 325. For example, the order may be transmitted via electronic means, e.g., using a Health Level 7 (HL7) interface, facsimile, electronic mail, Secure Socket Layer (SSL), HTTP, FTP, or other electronic interface as known in the art. Alternatively, the order may be sent to the laboratory using a paper form or other laboratory requisition. In some examples, method 300 may include transmitting a request for reimbursement to the payor at step 330. For example, the request for reimbursement may include payor-specific ordering criteria entered by a user or reflected on the order, as obtained through method 200 and/or method 300 disclosed herein.

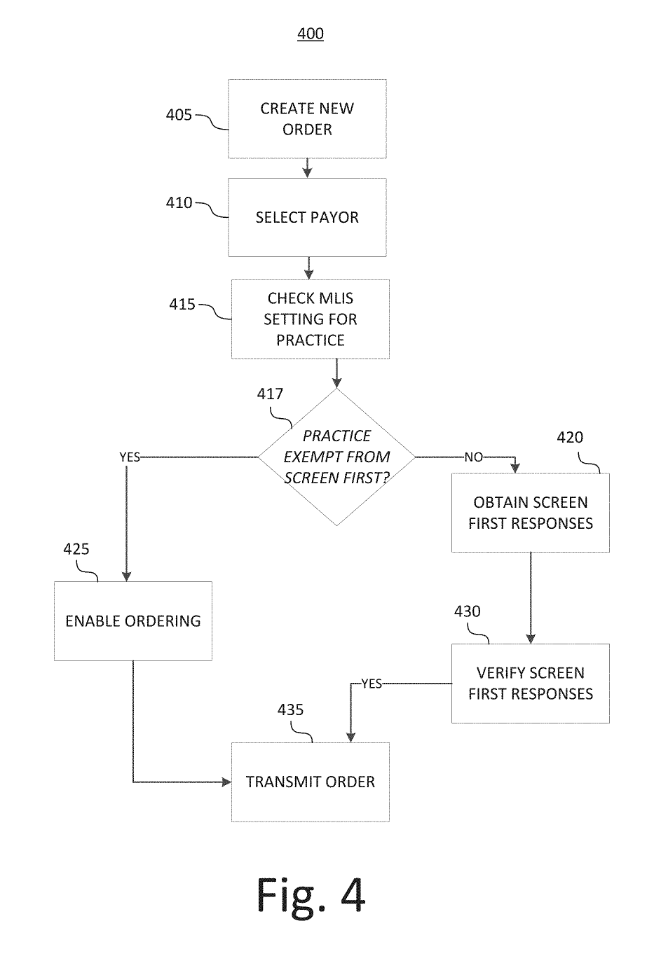

FIG. 4 is a flow chart illustrating an example method 400 for ordering a laboratory test for a biological sample. As illustrated, method 400 may include creating a new order at step 405 and selecting a payor at step 410. For example, steps 405 and 410 may be performed using a graphical user interface as described herein. Method 400 may also include checking a payor-specific set of ordering requirements at step 415. In some examples, if the MLIS setting indicates that the practice is exempt from a screen-first requirement at step 417, then ordering is enabled at step 425 and the order is transmitted to the laboratory at step 435. Alternatively, if the MLIS setting indicates that the practice is not exempt from a screen-first requirement at step 417, then the user may be required to obtain screen-first information at step 420 and verify the screen first responses at step 430. In some examples, the order may then be transmitted to the laboratory at step 435. In some examples, the transmitted order may then be submitted for reimbursement to the payor, if required by the payor. In some examples, the order may not be submitted to the payor unless requested.

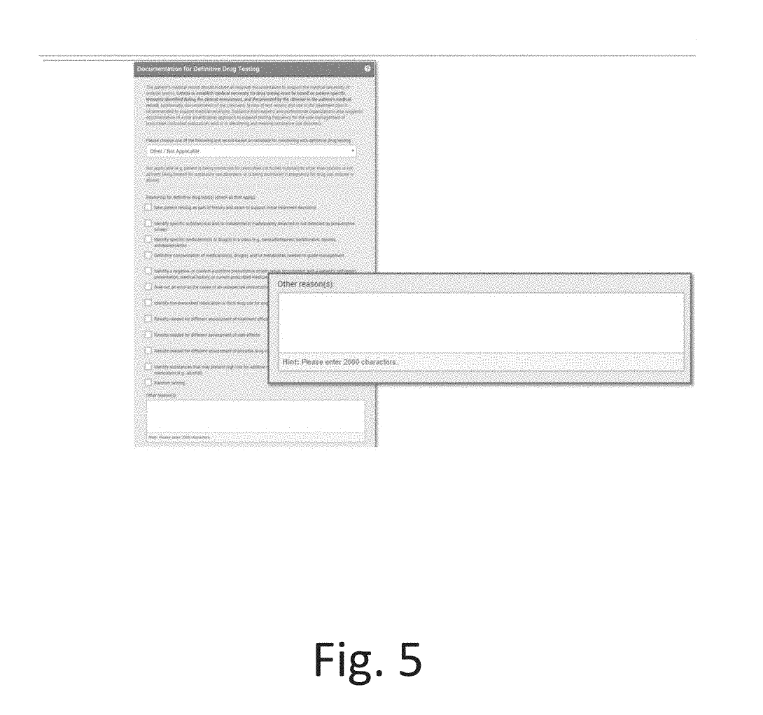

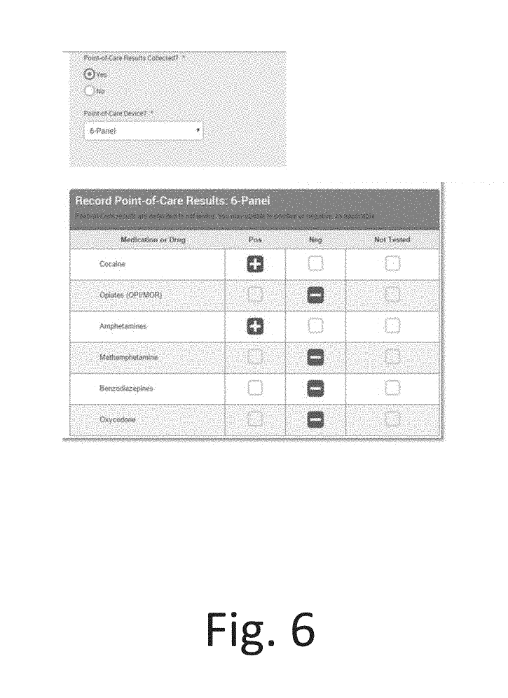

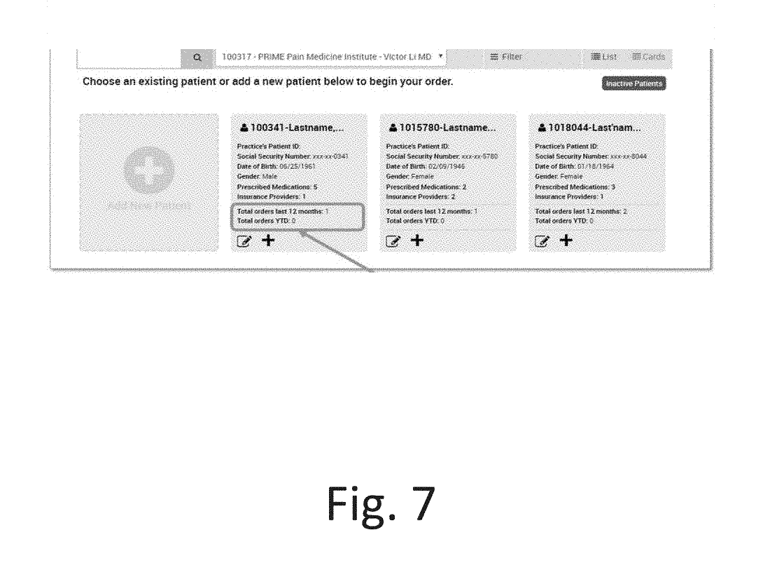

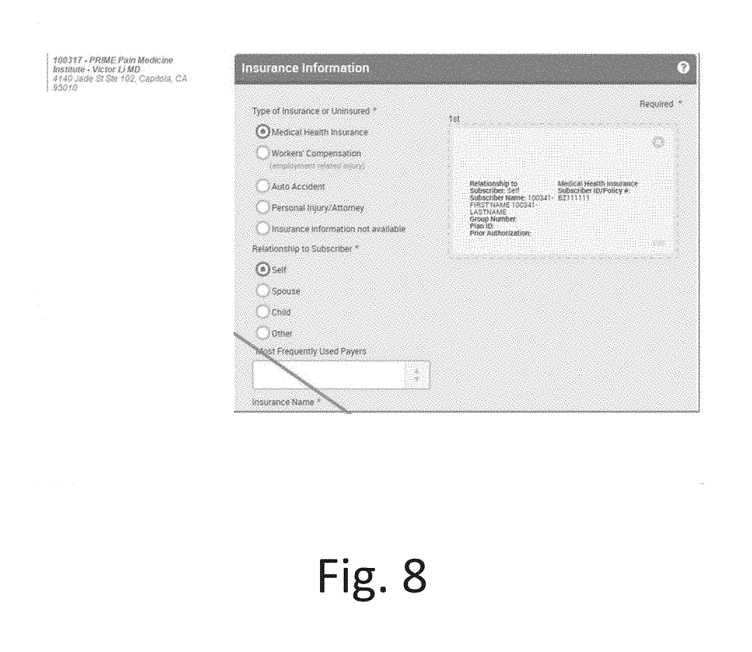

FIGS. 5-8 illustrate example screen shots of a GUI used to perform methods 200, 300, and/or 400. For example, the GUI screen shots illustrated in FIGS. 5 and 6 illustrate medical necessity and screen-first input screens. FIG. 7 illustrates an example order creation screen. And FIG. 8 illustrates an example payor selection screen.

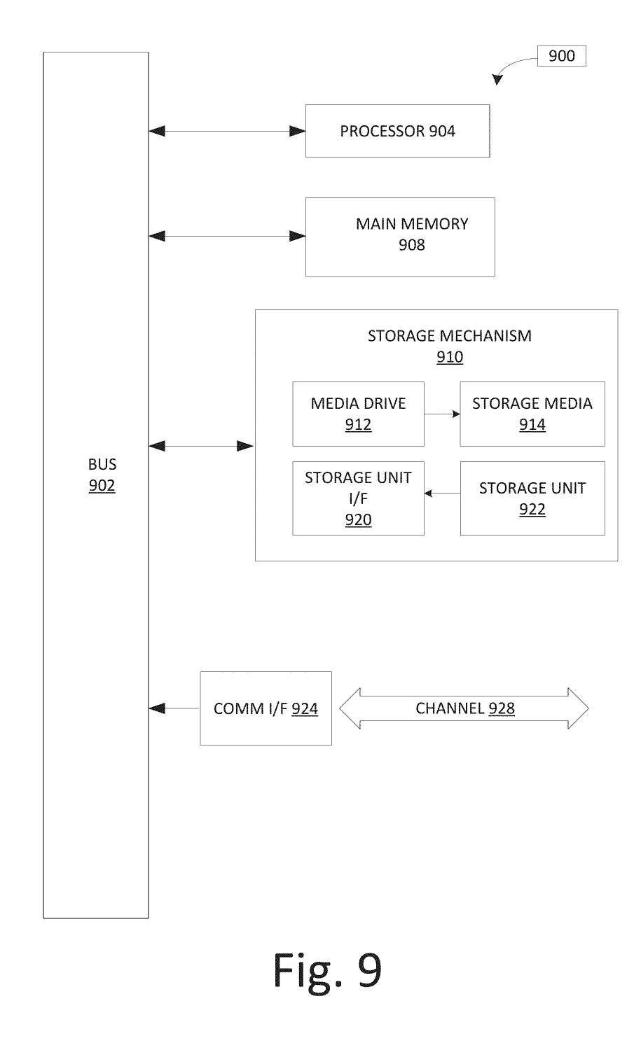

As used herein, the terms logical circuit and engine might describe a given unit of functionality that can be performed in accordance with one or more embodiments of the technology disclosed herein. As used herein, either a logical circuit or an engine might be implemented utilizing any form of hardware, software, or a combination thereof. For example, one or more processors, controllers, ASICs, PLAs, PALs, CPLDs, FPGAs, logical components, software routines or other mechanisms might be implemented to make up a engine. In implementation, the various engines described herein might be implemented as discrete engines or the functions and features described can be shared in part or in total among one or more engines. In other words, as would be apparent to one of ordinary skill in the art after reading this description, the various features and functionality described herein may be implemented in any given application and can be implemented in one or more separate or shared engines in various combinations and permutations. Even though various features or elements of functionality may be individually described or claimed as separate engines, one of ordinary skill in the art will understand that these features and functionality can be shared among one or more common software and hardware elements, and such description shall not require or imply that separate hardware or software components are used to implement such features or functionality.

Where components, logical circuits, or engines of the technology are implemented in whole or in part using software, in one embodiment, these software elements can be implemented to operate with a computing or logical circuit capable of carrying out the functionality described with respect thereto. One such example logical circuit is shown in FIG. 9. Various embodiments are described in terms of this example logical circuit 900. After reading this description, it will become apparent to a person skilled in the relevant art how to implement the technology using other logical circuits or architectures.

Referring now to FIG. 9, computing system 900 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special-purpose or general-purpose computing devices as may be desirable or appropriate for a given application or environment. Logical circuit 900 might also represent computing capabilities embedded within or otherwise available to a given device. For example, a logical circuit might be found in other electronic devices such as, for example, digital cameras, navigation systems, cellular telephones, portable computing devices, modems, routers, WAPs, terminals and other electronic devices that might include some form of processing capability.

Computing system 900 might include, for example, one or more processors, controllers, control engines, or other processing devices, such as a processor 904. Processor 904 might be implemented using a general-purpose or special-purpose processing engine such as, for example, a microprocessor, controller, or other control logic. In the illustrated example, processor 904 is connected to a bus 902, although any communication medium can be used to facilitate interaction with other components of logical circuit 900 or to communicate externally.

Computing system 900 might also include one or more memory engines, simply referred to herein as main memory 908. For example, preferably random access memory (RAM) or other dynamic memory, might be used for storing information and instructions to be executed by processor 904. Main memory 908 might also be used for storing temporary variables or other intermediate information during execution of instructions to be executed by processor 904. Logical circuit 900 might likewise include a read only memory (“ROM”) or other static storage device coupled to bus 902 for storing static information and instructions for processor 904.

The computing system 900 might also include one or more various forms of information storage mechanism 910, which might include, for example, a media drive 912 and a storage unit interface 920. The media drive 912 might include a drive or other mechanism to support fixed or removable storage media 914. For example, a hard disk drive, a floppy disk drive, a magnetic tape drive, an optical disk drive, a CD or DVD drive (R or RW), or other removable or fixed media drive might be provided. Accordingly, storage media 914 might include, for example, a hard disk, a floppy disk, magnetic tape, cartridge, optical disk, a CD or DVD, or other fixed or removable medium that is read by, written to or accessed by media drive 912. As these examples illustrate, the storage media 914 can include a computer usable storage medium having stored therein computer software or data.

In alternative embodiments, information storage mechanism 190 might include other similar instrumentalities for allowing computer programs or other instructions or data to be loaded into logical circuit 900. Such instrumentalities might include, for example, a fixed or removable storage unit 922 and an interface 920. Examples of such storage units 922 and interfaces 920 can include a program cartridge and cartridge interface, a removable memory (for example, a flash memory or other removable memory engine) and memory slot, a PCMCIA slot and card, and other fixed or removable storage units 922 and interfaces 920 that allow software and data to be transferred from the storage unit 922 to logical circuit 900.

Logical circuit 900 might also include a communications interface 924. Communications interface 924 might be used to allow software and data to be transferred between logical circuit 900 and external devices. Examples of communications interface 924 might include a modem or softmodem, a network interface (such as an Ethernet, network interface card, WiMedia, IEEE 802.XX or other interface), a communications port (such as for example, a USB port, IR port, RS232 port Bluetooth° interface, or other port), or other communications interface. Software and data transferred via communications interface 924 might typically be carried on signals, which can be electronic, electromagnetic (which includes optical) or other signals capable of being exchanged by a given communications interface 924. These signals might be provided to communications interface 924 via a channel 928. This channel 928 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 908, storage unit 920, media 914, and channel 928. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the logical circuit 900 to perform features or functions of the disclosed technology as discussed herein.

Although FIG. 9 depicts a computer network, it is understood that the disclosure is not limited to operation with a computer network, but rather, the disclosure may be practiced in any suitable electronic device. Accordingly, the computer network depicted in FIG. 9 is for illustrative purposes only and thus is not meant to limit the disclosure in any respect.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the technology disclosed herein. Also, a multitude of different constituent engine names other than those depicted herein can be applied to the various partitions.

Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “engine” does not imply that the components or functionality described or claimed as part of the engine are all configured in a common package. Indeed, any or all of the various components of an engine, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

I claim:

1. A computer implemented method of ordering a laboratory test for a biological sample collected from a patient, the method comprising:
obtaining, from a data store, multiple sets of payor-specific ordering guidelines;
obtaining, from a graphical user interface, an indication or a payor identity;
selecting, with a payor-compliance logical circuit, one of the sets of payor-specific ordering guidelines based on the indication of the payor identity;
displaying, on the graphical user interface, ordering guidelines from the set of payor-specific ordering guidelines; and
obtaining, from the graphical user interface, a set of patient-specific data required by the payor to issue a reimbursement for the laboratory test based on the selected set of payor-specific guidelines.

2. The computer implemented method of claim 1, wherein the payor-specific ordering guidelines comprise a medical necessity flag, a pre-screening flag, a frequency limit flag, or a list of payor-approved laboratory test types.

3. The computer implemented method of claim 1, wherein the biological sample comprises urine, blood, or oral fluid.

4. The computer implemented method of claim 1, wherein the laboratory test comprises a drug test.

5. The computer implemented method of claim 1, wherein the obtaining the indication of payor identity comprises displaying, on the graphical user interface, a list of available payors, and obtaining a user selection of a desired payor.

6. The computer implemented method of claim 2, further comprising:
setting the medical necessity flag to true if identifying a medical necessity is required by the payor identified by the indication of the payor identity;
displaying, on the graphical user interface, a medical necessity input field;
obtaining, from the graphical user interface, a user description of medical necessity entered into the medical necessity input field;
storing, in the data store, the user description of medical necessity;
transmitting an order for the laboratory test after obtaining the user description of medical necessity; and
transmitting a request for reimbursement to the payor, the request for reimbursement comprising the user description of medical necessity.

7. The computer implemented method of claim 2, further comprising:
setting the pre-screening flag to true if pre-screening is required by the payor identified by the indication of the payor identity;
displaying, on the graphical user interface, a pre-screening indicator;
obtaining a pre-screening criteria indicating information about a pre-screening test of the biological sample;
storing, in the data store, the pre-screening criteria;
transmitting an order for the laboratory test after obtaining the pre-screening criteria; and
transmitting a request for reimbursement to the payor, the request for reimbursement comprising the pre-screening criteria.

8. The computer implemented method of claim 2, further comprising:
setting the frequency limit flag to a payor-specific frequency threshold if a payor-specific frequency threshold is required by the payor identified by the indication of the payor identity; and
displaying, on the graphical user interface, the payor-specific frequency threshold and an indication of a frequency at which the laboratory test had been performed for the patient.

9. The computer implemented method of claim 8, further comprising displaying, on the graphical user interface, a warning message if the indication of the frequency at which the laboratory test had been performed for the patient is equal to or exceeds the payor-specific frequency threshold.

10. The computer implemented method of claim 2, further comprising:
displaying, on the graphical user interface, a warning message if the laboratory test does not match any of the payor-approved laboratory test types.

11. A system for ordering a laboratory test for a biological sample collected from a patient, the system comprising:
a data store, a payor-compliance logical circuit, and a graphical user interface, wherein the payor-compliance logical circuit comprises a processor and a non-transitory medium with computer executable instructions embedded thereon, the computer executable instructions configured to cause the processor to:
obtain, from the data store, multiple sets of payor-specific ordering guidelines;
obtain, from the graphical user interface, an indication or a payor identity;
select one of the sets of payor-specific ordering guidelines based on the indication of the payor identity;
display, on the graphical user interface, ordering guidelines from the set of payor-specific ordering guidelines; and
obtain, from the graphical user interface, a set of patient-specific data required by the payor to issue a reimbursement for the laboratory test based on the set of payor-specific guidelines.

12. The system of claim 11, wherein the payor specific ordering guidelines comprise a medical necessity flag, a pre-screening flag, a frequency limit flag, or a list of payor-approved laboratory test types.

13. The system of claim 11, wherein the biological sample comprises urine, blood, or oral fluid.

14. The system of claim 11, wherein the laboratory test comprises a drug test.

15. The system of claim 11, wherein the computer executable instructions are further configured to cause the processor to display, on the graphical user interface, a list of available payors, and obtaining a user selection of a desired payor.

16. The system of claim 12, wherein the computer executable instructions are further configured to cause the processor to:
set the medical necessity flag to true if identifying a medical necessity is required by the payor identified by the indication of the payor identity;
display, on the graphical user interface, a medical necessity input field;
obtain, from the graphical user interface, a user description of medical necessity entered into the medical necessity input field;
store the user description of medical necessity in the data store;
transmit an order for the laboratory test after obtaining the user description of medical necessity; and
transmit a request for reimbursement to the payor, the request for reimbursement comprising the user description of medical necessity.

17. The system of claim 12, wherein the computer executable instructions are further configured to cause the processor to:
set the pre-screening flag to true if pre-screening is required by the payor identified by the indication of the payor identity;
display, on the graphical user interface, a pre-screening indicator;
obtain a pre-screening criteria indicating information about a pre-screening test of the biological sample;
store the pre-screening criteria in the data store;
transmit an order for the laboratory test after obtaining the pre-screening criteria; and
transmit a request for reimbursement to the payor, the request for reimbursement comprising the pre-screening criteria.

18. The system of claim 12, wherein the computer executable instructions are further configured to cause the processor to:
set the frequency limit flag to a payor-specific frequency threshold if a payor-specific frequency threshold is required by the payor identified by the indication of the payor identity; and
display, on the graphical user interface, the payor-specific frequency threshold and an indication of a frequency at which the laboratory test had been performed for the patient.

19. The system of claim 18, wherein the computer executable instructions are further configured to cause the processor to display, on the graphical user interface, a warning message if the indication of the frequency at which the laboratory test had been performed for the patient is equal to or exceeds the payor-specific frequency threshold.

20. The system of claim 12, wherein the computer executable instructions are further configured to cause the processor to display, on the graphical user interface, a warning message if the laboratory test does not match any of the payor-approved laboratory test types.
